(19) United States
(12) Patent Application Publication
(10) Pub. No.: US 2014/0184901 A1
(43) Pub. Date: Jul. 3, 2014

(54) MOUNTING DEVICE FOR CAMERA MODULE

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventor: RONG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 14/015,747

(22) Filed: Aug. 30, 2013

(30) Foreign Application Priority Data
Dec. 28, 2012 (CN) 2012105820277

(51) Int. Cl. H04N 5/225

(52) U.S. Cl. CPC H04N 5/2251
USPC 348/373

(57) ABSTRACT

A mounting device for securing a camera module by spring pressure and without using screws includes a front plate, a positioning portion extending from the front plate, a latching portion, and a resilient member. The positioning portion defines a positioning slot configured for inserting a first end of a circuit board of the camera module. The resilient member is elastically deformable to engage with the latching portion and to abut and maintain spring pressure against a second end of the circuit board towards the first end to secure the circuit board to the front plate stably and without screws.

### BACKGROUND

1. Technical Field

The present disclosure relates to mounting devices, and particularly to a mounting device for a camera module.

2. Description of Related Art

Camera modules are in electronic devices such as mobile phones and computers. Generally, the camera module is adhered to a front cover of the electronic device and then secured to the front cover with screws, which is inconvenient and time consuming. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting device and a camera module.

FIG. 2 is an enlarged view of a circled portion II of the mounting device and the camera module of FIG. 1.

FIG. 3 is an assembled, isometric view of the mounting device and the camera module of FIG. 1.

FIG. 4 is a top view of the mounting device and the camera module of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

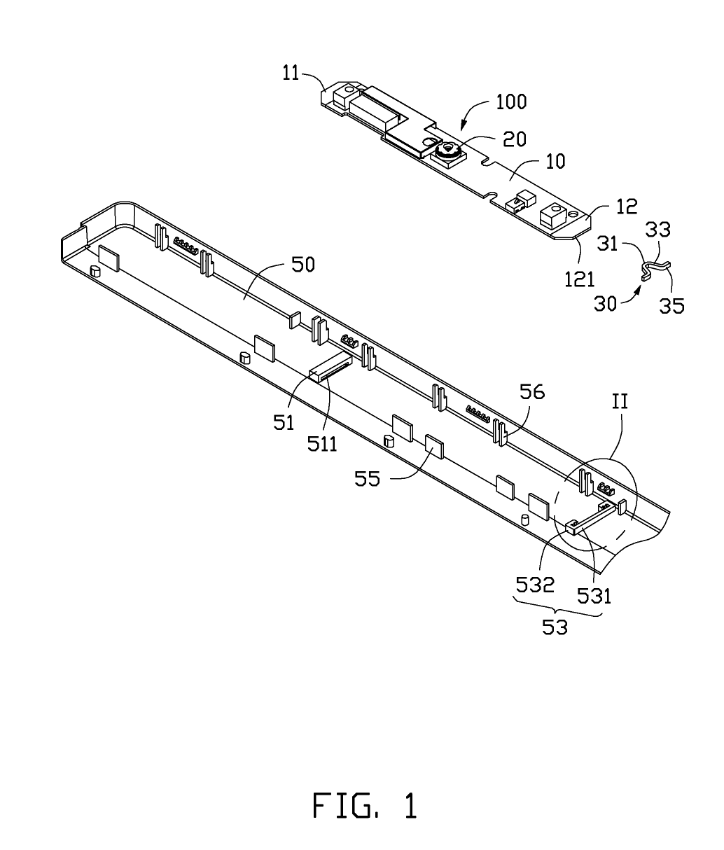

FIG. 1 shows one embodiment of a mounting device for securing a camera module 100. The camera module 100 includes a circuit board 10 and a camera 20. The circuit board 10 includes a first end 11 and a second end 12 opposite to the first end 11. The second end 12 includes a blocking edge 121. In one embodiment, the blocking edge 121 is substantially perpendicular to a top surface of the circuit board 10.

The mounting device includes a resilient member 30 and a front plate 50. The resilient member 30 includes a resisting piece 31, two resilient pieces 33, and two positioning pieces 35. The two resilient pieces 33 extend from opposite ends of the resisting piece 31. A first angle is defined between the resisting piece 31 and each resilient piece 33. The first angle is obtuse. Each positioning piece 35 extends from one of the two positioning pieces 35, and the two positioning pieces 35 extend in opposite directions. In one embodiment, the resisting piece 31 is substantially parallel to each positioning piece 35. When the resilient member 30 is located in an uncompressed initial position, a first distance is defined between the resisting piece 31 and each positioning piece 35.

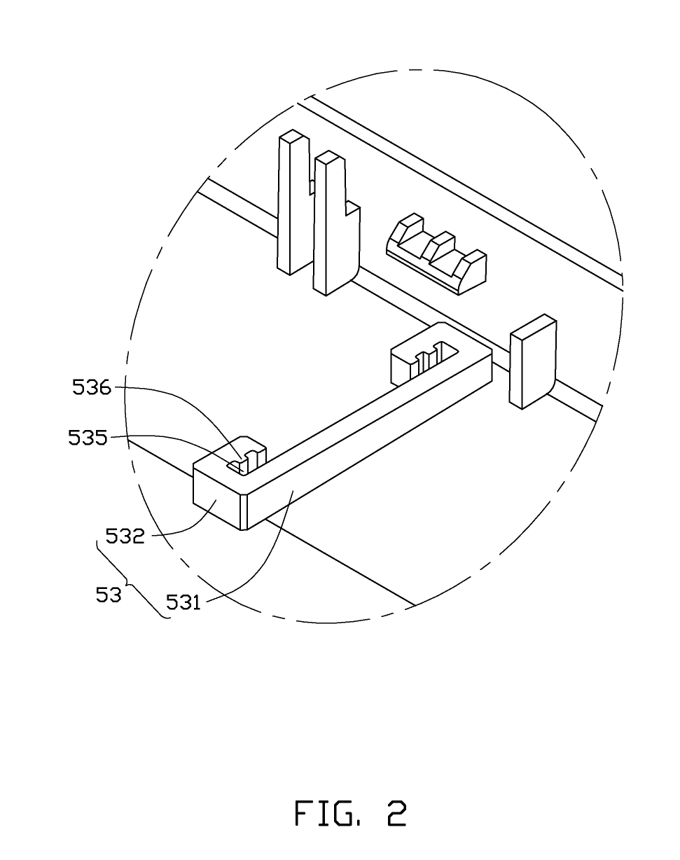

Referring to FIGS. 1 and 2, a limiting portion 51 and a latching portion 53 extend from the front plate 50. The limiting portion 51 defines a positioning slot 511. An extending direction of the positioning slot 511 is substantially parallel to the front plate 50. The latching portion 53 includes a first latching piece 531 and two second latching pieces 532 extending from the first latching piece 531. In one embodiment, the first latching piece 531 is substantially perpendicular to the font covering plate 50, and each second latching piece 532 is substantially “L” shaped. A latching slot 535 is defined between the first latching piece 531 and each second latching piece 532. A protrusion 536 extends from each second latching piece 532 into the latching slot 535. The latching slot 535 is used for engaging the positioning piece 35. A plurality of the first limiting pieces 55 and a plurality of second limiting pieces 56 extend from opposite ends of the front plate 50.

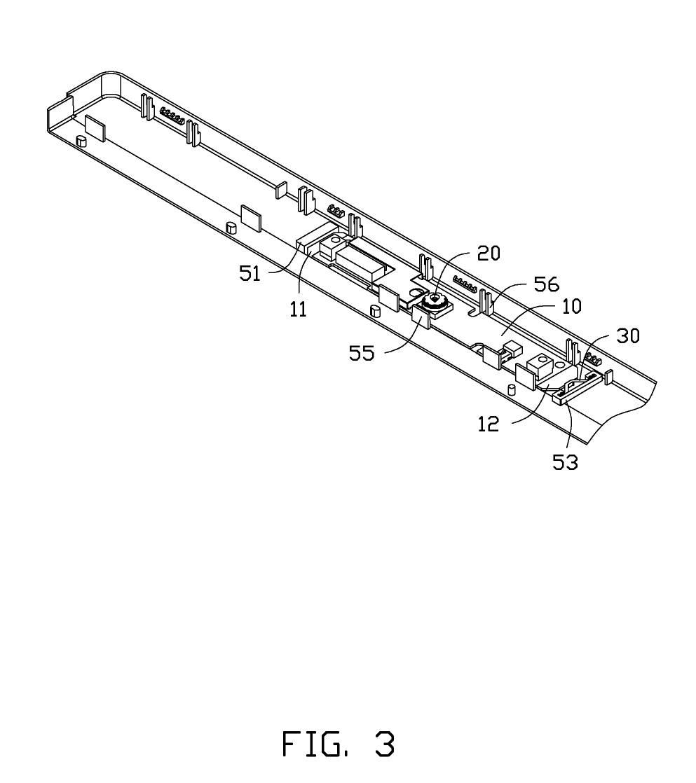

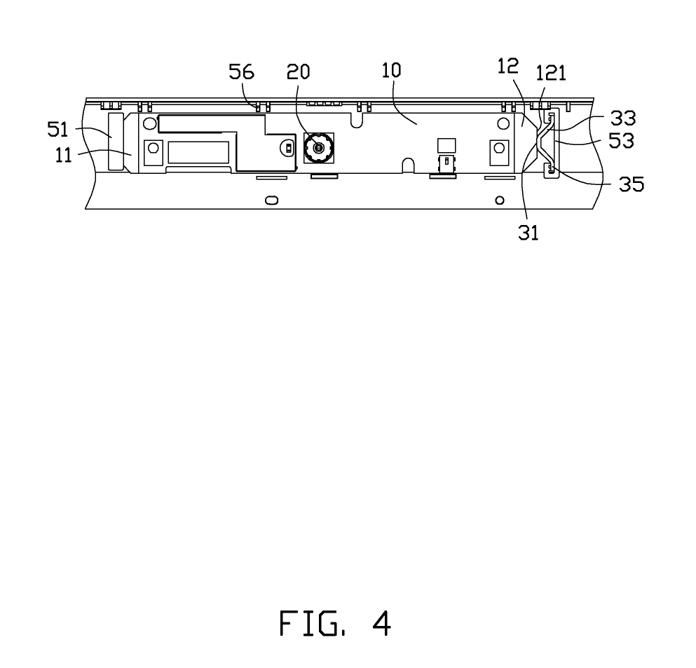

Referring also to FIGS. 3 and 4, in assembly, the resilient member 30 is placed on the front plate 50 with the two positioning pieces 35 inserted in the two latching slots 535. The camera module 100 is moved to the front plate 50 and located between the first limiting pieces 55 and the second limiting pieces 56. The first end 11 of the circuit board 10 is poised above the positioning slot 511. The second end 12 is pressed against the resilient member 30, to elastically deform the resilient piece 33, until the first end 11 of the circuit board 10 can be lowered to the front plate 50 and allowed to enter the positioning slot 511 by the pushing force of the resilient member 30 restoring itself. The two resilient pieces 33 are elastically deformed away from each other, and the two positioning pieces 35 are inserted into the two latching slots 535 further. The second end 12 is moved over the resilient member 30, and the blocking edge 121 abuts the resisting piece 31. The resisting piece 31 exerts elastic force to engage the circuit board 10 to the front plate 50. The protrusion 536 abuts the positioning piece 35, preventing the positioning piece 35 from disengaging from the latching slot 535. In this position, the resilient member 30 is located in a securing position, a second angle is defined between each resilient piece 33 and the resisting piece 31, and a second distance is defined between the resisting piece 31 and the positioning piece 35. The second angle is larger than the first angle. The first distance is greater than the second distance.

In disassembly, the two resilient pieces 33 are deformed towards each other to disengage the positioning piece 35 from the latching slot 535, allowing the second end 12 to be lifted from the front plate 50. Thus, the camera module 100 can be removed from the front plate 50 after the first end 11 is pulled out of the positioning slot 511.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure, to the full extent indicated by the broad general meaning of the terms in which the appended claims are expressed.

What is claimed is:

1. A mounting device comprising:
a front plate;
a positioning portion extending from the front plate and defining a positioning slot, and the positioning slot being configured for receiving a first end of a circuit board of a camera module;
a latching portion extending from the front plate and defining a latching slot; and
a resilient member engaged in the latching slot;
wherein the resilient member is elastically deformable, and the resilient member is configured to abut and maintain spring pressure against a second end of the circuit board, for securing the circuit board to the front plate; and the second end of the circuit board is opposite to the first end of the circuit board.

2. The mounting device of claim 1, wherein an extending direction of the positioning slot is substantially parallel to the front plate.

3. The mounting device of claim 1, wherein the resilient member comprises a resisting piece, a resilient piece, and a positioning piece; the resilient piece connects the resisting piece to the positioning piece, the positioning piece is engaged in the latching slot, and the resisting piece is configured for abutting the second end of the circuit board.

4. The mounting device of claim 3, wherein the resisting piece is configured for abutting a blocking edge of the second end, which is substantially perpendicular to the front plate.

5. The mounting device of claim 3, wherein the latching portion further comprises a protrusion in the latching slot, and the protrusion abuts the positioning piece, preventing the positioning piece from disengaging from the latching slot.

6. The mounting device of claim 3, wherein the resisting piece is substantially parallel to the positioning piece, and an obtuse angle is defined between the resisting piece and the resilient piece.

7. The mounting device of claim 1, wherein the latching portion comprises a first latching piece and a second latching piece connected to the first latching piece, the second latching piece is substantially “L” shaped, and the latching slot is defined between the first latching piece and the second latching piece.

8. The mounting device of claim 7, wherein the first latching piece is substantially perpendicular to the front plate.

9. The mounting device of claim 1, wherein a first limiting piece and a second limiting piece extending from the front plate, and the first limiting piece and the second limiting piece are configured for engaging the camera module therebetween.

10. A mounting device comprising:
a front plate;
a positioning portion extending from the front plate and defining a positioning slot, and the positioning slot being configured for receiving a first end of a circuit board of a camera module;
a latching portion extending from the front plate and comprising a first latching piece and two second pieces extending from opposite edges of the first latching piece, and a latching slot is defined between the first latching piece and each second latching piece; and
a resilient member engaged in the front plate in an initial position or a securing position;
wherein when the resilient member is in the initial position, the resilient member is located between the two second latching pieces and located outside the latching slot; and when the resilient member is in the securing position, the resilient member is elastically deformed, a part of the resilient member is engaged in the latching slot, and the resilient member is configured to abut and maintain spring pressure against a second end of the circuit board, for securing the circuit board to the front plate; and the second end of the circuit board is opposite to the first end of the circuit board.

11. The mounting device of claim 10, wherein an extending direction of the positioning slot is substantially parallel to the front plate.

12. The mounting device of claim 10, wherein the resilient member comprises a resisting piece, a resilient piece, and a positioning piece; the resilient piece connects the resisting piece to the positioning piece, when the resilient member is in the initial position, the positioning piece is located between the two second latching pieces and located outside the latching slot; and when the resilient member is in the securing position, the positioning piece is engaged in the latching slot, and the resisting piece is configured for abutting the second end of the circuit board.

13. The mounting device of claim 12, wherein the resisting piece is configured for abutting a blocking edge of the second end, which is substantially perpendicular to the front plate.

14. The mounting device of claim 12, wherein the latching portion further comprises a protrusion in the latching slot, and the protrusion abuts the positioning piece, preventing the positioning piece from disengaging from the latching slot.

15. The mounting device of claim 12, wherein the resisting piece is substantially parallel to the positioning piece, and an obtuse angle is defined between the resisting piece and the resilient piece.

16. The mounting device of claim 10, wherein each second latching piece is substantially “L” shaped.

17. The mounting device of claim 10, wherein the first latching piece is substantially perpendicular to the front plate.

18. The mounting device of claim 10, wherein a first limiting piece and a second limiting piece extending from the front plate, and the first limiting piece and the second limiting piece are configured for engaging the camera module therebetween.
